(19) United States
(12) Patent Application Publication
(10) Pub. No.: US 2009/0225781 A1
(43) Pub. Date: Sep. 10, 2009

(54) System, method and computer program product for bulk event transfer

(75) Inventor: Prasad Yendluri, San Jose, CA (US)

Correspondence Address: VENABLE LLP, P.O. BOX 34385, WASHINGTON, DC, 20043-9998, US

(73) Assignee: Software AG, Inc., Darmstadt (DE)

(21) Appl. No.: 12/073,662

(22) Filed: Mar. 7, 2008

(51) Int. Cl. H04J 3/24

(52) U.S. Cl. 370/474

(57) ABSTRACT

A system, method and computer program product related to the bulk transfer of events are provided. The events may be transferred between various nodes on a network. A first node on the network may have various events to be transmitted over the network to other nodes. The events may be arranged into distinct messages. Some of the messages may be intended for the same destination node. Those messages intended for the same destination node may be combined together into a single message. The single message may be transmitted over the network to the destination node. The destination node may then process the single message to retrieve the plurality of messages from the single message.

### CROSS REFERENCE TO RELATED APPLICATIONS

This application is related to co-pending U.S. patent application Ser. No. ______, entitled “Distributed Business Process Tracking”, attorney docket no. 30478-255291 and Ser. No. ______, entitled “Policy Negotiation System and Method”, attorney docket no. 30478-255294, each filed on a date even herewith and each of which is incorporated herein by reference.

### BACKGROUND OF THE INVENTION

The present invention is related generally to a system, method and computer program product for the bulk transfer of events.

Modern businesses rely on information technology (IT) to assist in carrying out business tasks. An enterprise's IT infrastructure needs to consistently perform to specification to ensure the success of the business. The IT infrastructure may be used for an enterprise's communication, database management, inventory tracking, shipment records, website management, business-to-business (B2B) ecommerce, business-to-consumer (B2C) ecommerce, accounting, billing, order tracking, customer support tracking, document management, and a possibly infinite number of other tasks.

An enterprise applies business process management (BPM) and Business Application Monitoring (BAM) in order to continuously improve its performance, through proactive controls and agile responses to adjusting and optimizing the many active processes which collectively define its business outcomes. The disciplined frameworks of Business Process Management and Business Application Monitoring are the most advanced and mature frameworks for effecting total process excellence, representing a culmination of the past fifty years of achievements in methods, tools, and systems. It is a breakthrough in optimizing large-scale complex adaptive systems—like the modern business.

BPM and BAM may generate large amounts of data and events that need to be transmitted and processed. The data and events may include a large number of small messages. Transmitting and processing the large number of separate messages may consume excessive network bandwidth and processing overhead unnecessarily.

### SUMMARY

Embodiments of the invention provide a method, comprising: providing a plurality of messages each formatted according to a same protocol, each of the plurality of messages being intended for a same destination; combining the plurality of messages into a single message that is formatted according to the same protocol and further comprising placing the plurality of messages into a body of the single message.

A further embodiment provides a method, comprising: providing a first node on which a plurality of different processes are running, the process providing notices to be sent to other nodes: receiving the notices at a process log; generating a respective message for each notice in the process log, the message being formatted according to a same protocol; determining the messages intended for a same destination node; combining the messages intended for the same destination node into a body of a wrapper message, the wrapper message being formatted according to the same protocol and monitoring the messages being preserved in the body as distinct messages formatted according to the same protocol; and sending the wrapper message to the same destination node based on the wrapper message at a predetermined time.

According to another embodiment, a method, comprises: receiving at a node a wrapper message formatted according to a protocol and including a header and a body, the body including a plurality of distinct messages formatted according to the protocol; decoding the header to determine the number of messages in the body of the wrapper message.

In a further embodiment a method, comprises: receiving a plurality of requests from a requester at a provider; generating respective responses to the requests at the provider; formatting the responses according to a protocol; combining the responses for the same requester into a single response message formatted according to the same protocol, the responses being arrange in a body of the response message; providing the response message from the provider via a network to the requester as a response to the plurality of requests.

Another embodiment provides a computer based system for monitoring a process, the system comprising: a process log including log entries formatted accruing to a protocol; and a notification manager adapted to determine if the log entries in the process log are for a same destination, and if the log entry in the process log is for the same destination, collect the log entries from the process log, generate a wrapper message including the log entries and formatted according to the protocol, and send the log entry to the client.

### BRIEF DESCRIPTION OF THE DRAWINGS

Embodiments of the invention will now be described in connection with the associated drawings, in which:

FIG. 1 depicts a block diagram of system according to an embodiment of the present invention;

FIG. 2 illustrates an example of a message according to an embodiment of the present invention;

FIG. 3 illustrates an example of a message according to an embodiment of the present invention;

FIGS. 4A and 4B illustrate examples of message exchange according to the prior art and to an embodiment of the present invention; and

FIG. 5 illustrates another system according to an embodiment of the present invention.

### DETAILED DESCRIPTION OF THE INVENTION

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer).

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Embodiments of the present invention relate to the bulk transfer of events and/or associated data. The events or data may be transferred between various nodes on a network. A first node on the network may have various events or data to be transmitted over the network to other nodes. The events or data may be arranged into distinct messages. Some of the messages may be intended for the same destination node. Those messages intended for the same destination node may be combined together into a bulk message. The bulk message may be transmitted over the network to the destination node. The bulk message may be a single message including a plurality of distinct messages. The destination node may then process the bulk message to retrieve the plurality of messages from the bulk message.

The messages may be formatted according to a same protocol. The messages may be distinct from each other and generated by different process executing on the first node. The distinct messages may be combined into the bulk message, also referred to as a wrapper message. The bulk message may formatted according to the same protocol as the plurality of messages. The combining of the distinct messages into a bulk message may be done at a predetermined time, for example, such as every second, or may be done upon occurrence of an event, such as when a particular number of messages to be sent to the same destination node is accumulated.

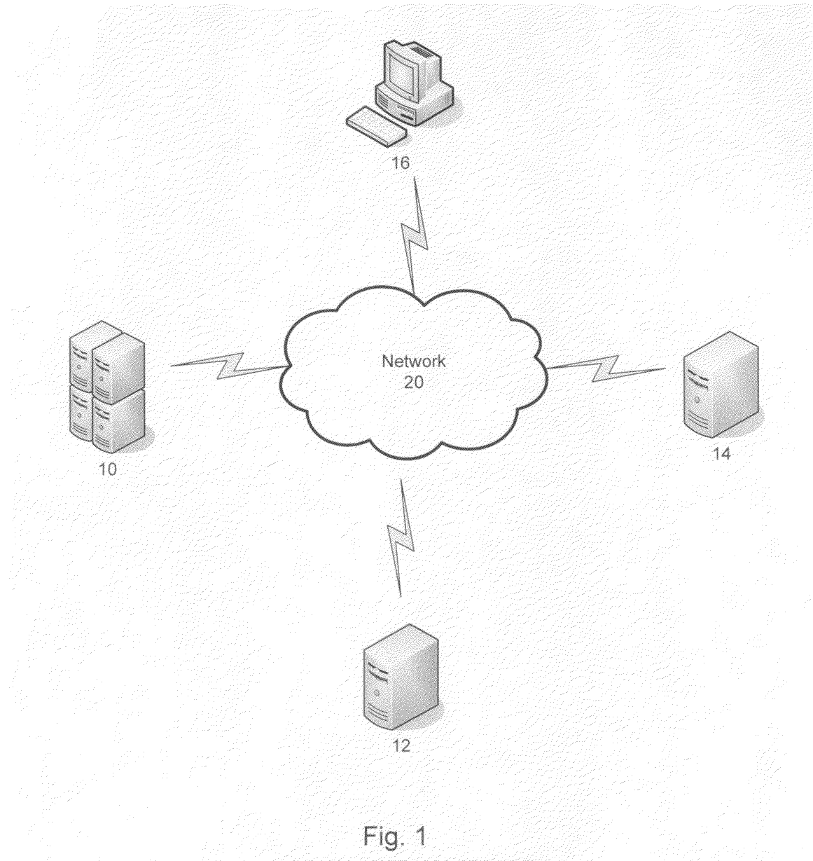

FIG. 1 illustrates an exemplary system implementing an embodiment of the present invention. The system includes a number of nodes 10, 12, 14, 16 that may communicate with each other or other nodes via a network 20. One or more processes may be running on one of the nodes, for example node 10. As the processes execute, there may be data generated, for example an event notification message, that is to be sent to another node. A number of different messages may be generated by the one or more processes. The messages may be formatted according to the same protocol, for example, the simple object access protocol (SOAP). Those messages that are intended for the same destination may be identified and combined into a single message to be sent that destination, for example, node 14. The identification and combination of the messages may be done at predetermined intervals, for example, at a predetermined time interval, such as, every second. At that time, the messages may be examined to identify those messages intended for node 14. Those messages intended for node 14 may be combined into a single message and transmitted to node 14. Alternatively, the messages intended for the same destination may be identified and stored, for example, in a log. When a predetermined number of messages is present in the log, the messages may be appropriately combined into a bulk message and transmitted to their respective destinations. The single message may be formatted according to the same protocol as the plurality of messages combined therein, for example, SOAP.

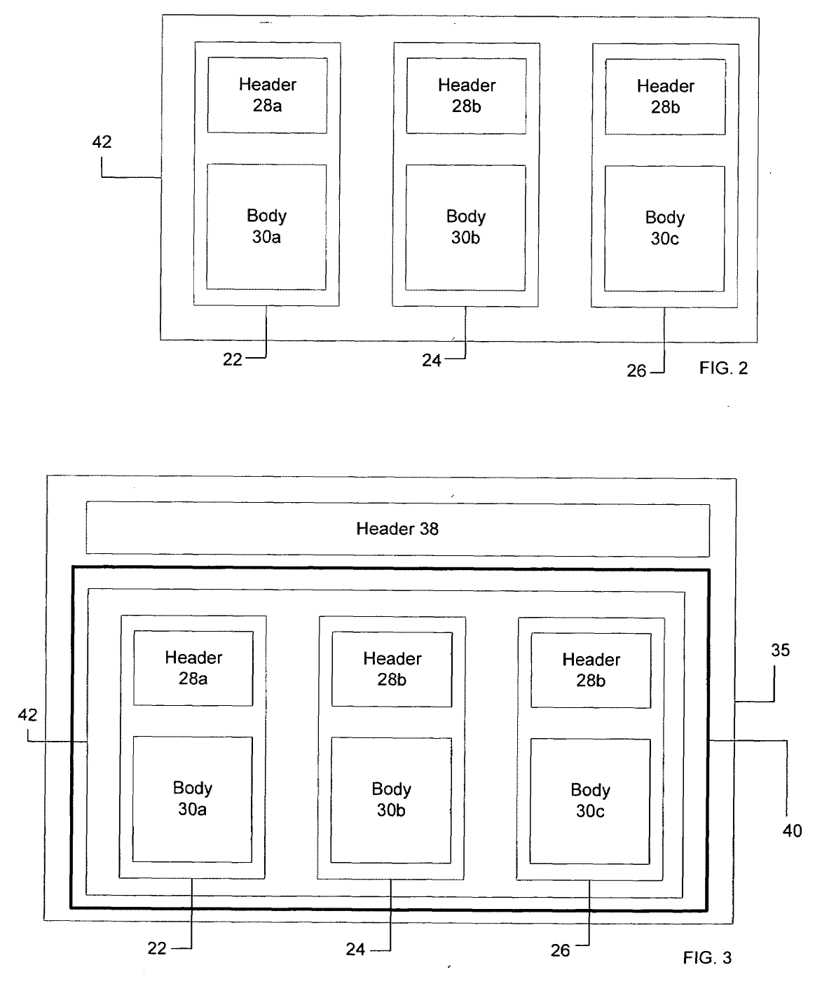

FIGS. 2 and 3 illustrate an example of a plurality of messages combined into a single message. In the example shown in FIG. 3, a plurality of distinct messages 22, 24, 26, in this case SOAP messages 22, 24, 26, are shown. Each of the SOAP messages 22, 24, 26 includes a respective header 28a-c and a respective body 30a-c. The header 28a-c of the messages may include the total number of wrapped messages and other contextual information such as, the identity of the sender of the wrapped message, identity of the receiver node, date and time-stamp of the message transmission etc. The body 30a-c of the messages may include the data intended for the destination node. For example, the body 30a-c may include the event notification information requested by the destination node. Each of the messages 22, 24, 26 may be distinct messages that each conform to the same protocol, here SOAP. Each of the messages 22, 24, 26 may have their own distinct header 28a-c and body 30a-c including different information.

The plurality of messages 22, 24, 26 may be combined or “wrapped” into a single wrapper message 35. The wrapper message 35 may be formatted according to the same protocol as the plurality of messages. In the example shown, the single message 35 is formatted according to SOAP. The single message 35 may also include a header 38 and a body 40. The header 38 may include information identifying each of the distinct messages included in the body, as well as the total number of wrapped messages and other contextual information such as, the identity of the sender of the wrapped message, identity of the receiver node, date and time-stamp of the message transmission etc. The body 40 of the wrapper message 35 may include the plurality of messages 22, 24, 26. The plurality of messages 22, 24, 26 may be preserved as distinct messages within the body 40.

As shown in FIG. 2 the plurality of messages 22, 24, 26 may be arranged in an inner wrapper 42. The inner wrapper 42 may be disposed within the body 40 of the wrapper message 35. The messages 22, 24, 26 may be arranged in, for example, an XML wrapper that forms the body of a SOAP message. This permits multiple SOAP messages to be sent in the body/payload of a single SOAP message. In general this approach to encasing multiple inner complete messages in a wrapper, permits the wrapped message to conform to the format of the protocol used to transfer the message.

Below is an example of how to facilitate carrying multiple events in a single SOAP message.

### Example When Using SOAP 1.2

### Normal SOAP Message

```
<?xml version=“1.0”?>
<soap12:Envelope
xmlns:soap=“http://www.w3.org/2003/05/soap-envelope”>
<soap12:Header>
  . . .
  . . .
</soap12:Header>
<soap12:Body>
  . . .
  . . .
</soap12:Body>
</soap12:Envelope>
```

Bulk events in a single SOAP Message. The namespace prefix “bet” below stands for “bulk event transfer” and is a place holder name.

```
<?xml version=“1.0”?>
<soap12:Envelope xmlns:soap12=http://www.w3.org/2003/05/soap-
envelope
            xmlns:wsa=“http://www.w3.org/2005/08/addressing”
            xmlns:bet=http://www.softwareAG.com/bulkevent/>
  <soap12:Header>
    <bet:Bulkevent soap:mustUnderstand=“1”>
      3 ← Indicates number of embedded SOAP messages. Should
be >= 2 integer
    </bet:Bulkevent>
    <wsa:MessageID>http://example.com/6B29FC40-CA47-1067-B31D-
00DD010662DA</wsa:MessageID>
    <wsa:From>IdentityOfTheSender</wsa:From>
    <wsa:To>http://example.com/fabrikam/Purchasing</wsa:To>
    <timestamp>2008-03-30T11:25:00Z</timestamp>
    </soap12:Header>
  . . .
  . . .
  <soap12:Body>
    <bet:Bulkevent-Wrapper>
```

| | |
|---|---|
| <soap12:Envelope . . . > | ← Embedded SOAP Message 1 |
| . . . | |
| . . . | |
| </soap12:Envelope> | |
| <soap12:Envelope . . . > | ← Embedded SOAP Message 2 |
| . . . | |
| . . . | |
| </soap12:Envelope> | |
| <soap12:Envelope . . . > | ← Embedded SOAP Message 3 |
| . . . | |
| . . . | |
| </soap12:Envelope> | |
| </bet:Bulkevent-Wrapper> | |
| </soap12:Body> | |
| </soap12:Envelope> | |

### When Using SOAP 1.1

All that changes is the namespace prefix “soap12” is changed to “soap11” and the namespace string “http://www.w3.org/2003/05/soap-envelope” is changed to “http://schemas.xmlsoap.org/soap/envelope/”

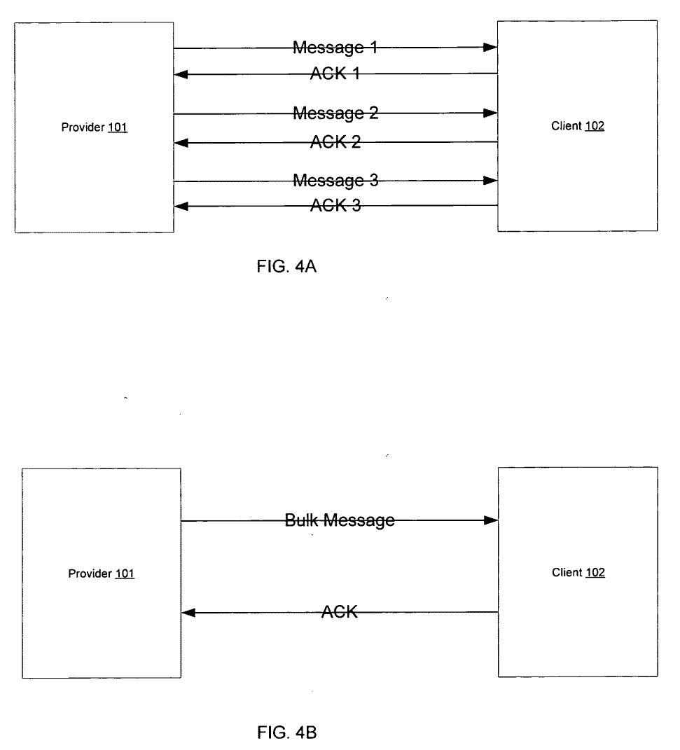

FIG. 4A illustrates the round trips when not using the bulk message as opposed to the round trip when using a bulk message according to an embodiment of the invention, shown in FIG. 4B.

Accordingly, a plurality of messages formatted according to a protocol may be combined into another message that is also formatted according to the same protocol. The other message, and the plurality of messages contained therein, may be transmitted to an intended destination based on the information in a header of the other message.

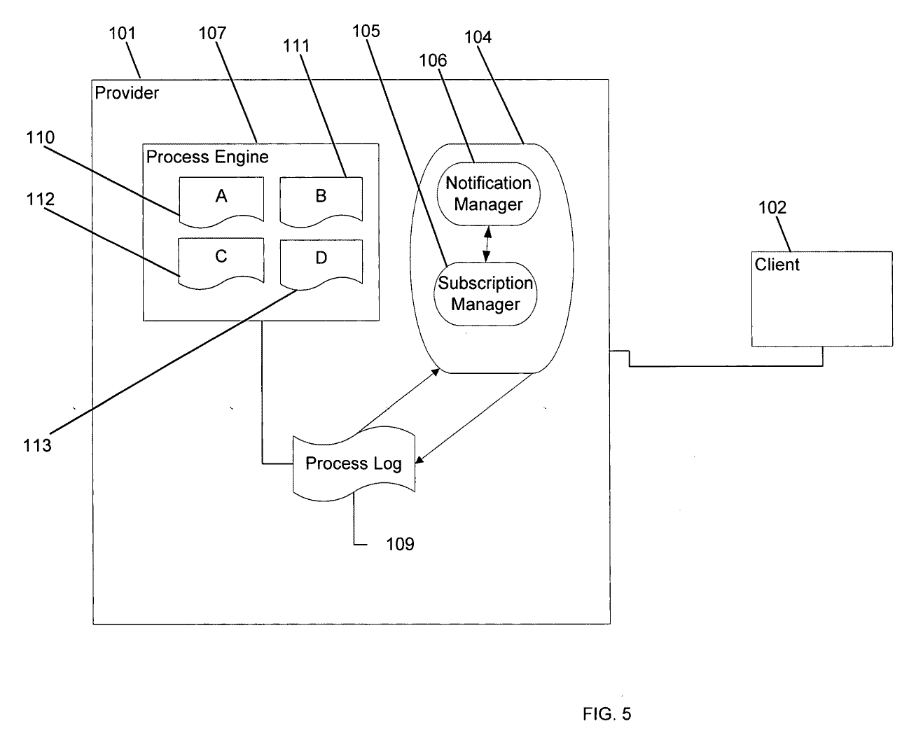

FIG. 5 depicts an exemplary system for distributed business process tracking that may be used in connection with exemplary embodiments of the present invention. A client 102 may initiate a distributed business process with any number of computer systems, each of which may be a provider 101. The following process will be described with respect to one provider 101, although there may be more than one provider 101 involved in the distributed business process. The client 102 may interact with each provider 101 in the same manner. The client 102 may desire to track the progress of a business process initiated with the provider 101. As the business process is executed by the provider 101, notifications may be generated and sent to the client 102. The client 102 may correlate the notifications to the business process, which may allow the client 102 to track the status of the business process using the notifications. A large number of relatively short event notification messages may be created.

The provider 101 may be any computer system that may be used for performing business processes. The provider 101 may be connected to a network, and may receive requests for the performance of distributed business processes from any other computer system connected to the network.

The client 102 may be any computer system that may initiate a distributed business process by requesting the performance of the distributed business process by the provider 101. The client 102 may be connected to the same network as the provider 101, and may send requests for the performance of distributed business processes to the provider 101 over the network. The client 102 may track the distributed business process as the process is performed by the provider 101 through notifications from the provider 101.

A subscription manager 105 may handle requests for subscriptions to notifications for processes from the client 102. Any suitable combination of hardware and software may be used to implement the subscription manager 105. For example, the subscription manager 105 may be a software component of a web service 104, and may be used to process subscription requests received by the provider 101 and generate confirmations of the subscriptions requests to be sent to the client 102. The subscription manager 105 may set up requested subscriptions on the notification manager 106.

The notification manager 106 may collect notifications for process types subscribed to by the client 101 and send the notifications to the client 101. Any suitable combination of hardware and software may be used to implement the notification manager 106. For example, the notification manager 106 may be a software component of a web service 104.

A process engine 107 may be any combination of hardware and software in the provider 101 suitable for performing a distributed business process. For example, the process engine 107 may be a processor in the provider 101 running specialized business transaction software.

A process log 109 may be any combination of hardware and software in the provider 101 suitable for storing log entries generated by the process engine 107 when performing a distributed business process. When the process engine 107 performs a distributed business process, log entries may be generated at various points during the performance for each of the process types being utilized. For example, if the process engine 107 is performing a purchase order process, a process type for checking inventory kept on another computer system for the item to be purchase may be utilized. Log entries may be generated, for example, when the process for checking inventory starts, when the request for the inventory check has been received and acknowledged by the other computer system, when the result of the inventory check has been returned to the provider 101, and when the process engine 107 processes the result of the inventory check. These log entries may be stored in the process log 109. In an exemplary embodiment, the event notification messages are created fro entries in the process log. Alternatively, the process log may store event notification messages.

Process A 110, Process B 111, Process C 112, and Process D 113 may be exemplary processes that may be utilized by the process engine 107 in the performance of a distributed business process. Each of the processes A 110, B 111, C 112 and D 113 may be used by the process engine 107 to perform a different part of the distributed business process. For example, process A 110 may be used for communicating with another computer system to check inventory, while process B 112 may be used for communicating with a computer system containing financial information.

The notification manager 106 may create a message for each of the notifications stored in the log. The notification manager 106 may also combine a plurality of distinct messages intended for the same destination into a wrapper message. The plurality of messages may be generated based on notifications from various ones of the processes A 110, B 111, C 112 and D 113. The notification manager 106 may generate the messages at a predetermined time interval, for example every second, and then combine the messages intended for the same destination into the wrapper message. Alternatively, the process log 109 may store notifications, messages or other data intended for the same destination in dedicated portions of the process log 109. The process log 109 may also create or store messages. The notification manager 106 may track the number of notifications, messages or other data within the process log and generate and send the wrapper message when there is a predetermined number of notifications, messages or other data for the same destination in the process log 109 or when the preset time interval has expired. The process log may also notify the notification manager 106 when the predetermined number of notifications have accumulated.

A predetermined time interval at which to send the wrapper message to the client may be agreed upon between the client 102 and the provider 101. The client 102 and the provider 101 may have a policy negotiation, during which the client 102 and provider 101 agree on the predetermined time interval or other policy for transmitting and receiving the wrapper message.

The client 102 may expect the wrapper message to arrive at the predetermined time. The client 102 may examine messages arriving at approximately the predetermined time to identify the wrapper message. Once identified at the client 102, the wrapper message may be processed to retrieve the plurality messages from within the body of the wrapper messages. The header of the wrapper message may indicate that the wrapper message is a bulk message and identify the particular number of distinct messages in the wrapper message. The client 102 may process the header to obtain this information and then process the information within the body of the wrapper message accordingly.

Although this invention has been described in certain specific embodiments, many additional modifications and variations would be apparent to those skilled in the art. It is, therefore, to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description. The invention, therefore, as defined in the appended claims, is intended to cover all such changes and modifications as fall within the true spirit of the invention.

What is claimed is:

1. A method, comprising:
providing a plurality of messages each formatted according to a same protocol, each of the plurality of messages being intended for a same destination;
combining the plurality of messages into a single message that is formatted according to the same protocol;
placing the plurality of messages into a body of the single message.

2. The method of claim 1, wherein the single message includes a header, and transmitting the plurality of messages to the same destination based on the header of the single message.

3. The method of claim 1, wherein combining the plurality of messages comprises maintaining the plurality of messages as distinct messages in the body of the wrapper message.

4. The method of claim 3, wherein combining the plurality of messages comprises arranging the plurality of messages in an inner wrapper this is disposed in the body of the wrapper message.

5. The method of claim 1, further comprising generating the plurality of messages from different processes executing on a first node in a network.

6. The method of claim 1, further comprising sending the single message to the same destination at a predetermined time.

7. The method of claim 1, wherein the same destination is a second node on the network and further comprising receiving the single message at the second node;
identifying the single message as containing the plurality of messages; and
retrieving the plurality of messages from the single message

8. A method, comprising:
providing a first node on which a plurality of different processes are running, the process providing notices to be sent to other nodes:
receiving the notices at a process log;
generating a respective message for each notice in the process log, the message being formatted according to a same protocol;
determining the messages intended for a same destination node;
combining the messages intended for the same destination node into a body of a wrapper message, the wrapper message being formatted according to the same protocol and monitoring the messages being preserved in the body as distinct messages formatted according to the same protocol; and
sending the wrapper message to the same destination node based on the wrapper message at a predetermined time.

9. The method of claim 8, the wrapper message including a header comprising at least one of identity of a sender, identity of a receiver, timestamp of transmission or a number of wrapped messages.

10. The method of claim 8, wherein the predetermined time is one of a time interval or when a predetermined number of messages for the same node are present in the process log are available for transmission

11. The method of claim 8, negotiating at the first node with the destination node to agree on the predetermined time.

12. The method of claim 8, wherein the protocol is XML based.

13. The method of claim 8, wherein the protocol is SOAP.

14. The method of claim 8, wherein the wrapper message is platform independent.

15. The method of claim 8, wherein combining the messages comprising placing the messages in an inner wrapper; and
arranging the inner wrapper in the body of the wrapper message.

16. A method, comprising:
receiving at a node a wrapper message formatted according to a protocol and including a header and a body, the body including a plurality of distinct messages formatted according to the protocol;
decoding the header to determine the number of messages in the body of the wrapper message.

17. The method of claim 16, further comprising:
correlating the messages based on the individual message headers and protocol wrappers.

18. A method, comprising:
receiving a plurality of requests from a requester at a provider;
generating respective responses to the requests at the provider;
formatting the responses according to a protocol;
combining the responses for the same requestor into a single response message formatted according to the same protocol, the responses being arrange in a body of the response message;
providing the response message from the provider via a network to the requester as a response to the plurality of requests.

19. A computer based system for monitoring a process, the system comprising:
a process log including log entries formatted accruing to a protocol; and
a notification manager adapted to determine if the log entries in the process log are for a same destination, and if the log entry in the process log is for the same destination, collect the log entries from the process log, generate a wrapper message including the log entries and formatted according to the protocol, and send the log entry to the client.
